(19) United States
(12) Patent Application Publication
(10) Pub. No.: US 2014/0365892 A1
(43) Pub. Date: Dec. 11, 2014

(54) METHOD, APPARATUS AND COMPUTER READABLE STORAGE MEDIUM FOR DISPLAYING VIDEO PREVIEW PICTURE

(71) Applicant: TENCENT TECHNOLOGY (SHENZHEN) COMPANY LIMITED, Shenzhen (CN)

(72) Inventors: Ning JIANG, Shenzhen (CN); Chunhui FU, Shenzhen (CN)

(21) Appl. No.: 14/304,095

(22) Filed: Jun. 13, 2014

Related U.S. Application Data
(63) Continuation of application No. PCT/CN2014/074858, filed on Apr. 4, 2014.

(30) Foreign Application Priority Data
Jun. 8, 2013 (CN) 201310228293.4

(51) Int. Cl. G06F 3/0484; G06F 3/0482; G06F 3/0488

(52) U.S. Cl. CPC G06F 3/04842; G06F 3/0488; G06F 3/0482
USPC 715/719

(57) ABSTRACT

A method, apparatus and computer readable storage medium for displaying a video preview picture are disclosed, which belong to the field of computer technology. The method includes receiving an operation signal for an item of a target video in a video list displayed on a screen; acquiring video preview picture or pictures corresponding to the target video according to pre-stored correspondence between videos and video preview pictures; and displaying the video preview picture corresponding to the target video. Thereby, the processing efficiency of a video preview procedure can be improved.

### CROSS-REFERENCE TO RELATED APPLICATIONS

This application is a continuation of International Patent Application No. PCT/CN2014/074858, entitled “Method, Apparatus and Computer Readable Storage Medium for Displaying Video Preview Picture,” filed on Apr. 4, 2014, which claims priority benefit of Chinese Patent Application No. CN201310228293.4, entitled “Method and Apparatus for Displaying Video Preview Picture,” filed on Jun. 8, 2013, the disclosures of which are herein incorporated by reference in their entireties.

### TECHNICAL FIELD

The present disclosure relates to the field of computer technology, and particularly to a method, apparatus and computer readable storage medium for displaying a video preview picture.

### BACKGROUND

With the rapid development of terminal technology and mobile communication technology, mobile terminals, such as smart phones, tablet computers and the like, have been popularized rapidly, becoming indispensable communication tools in people's lives, and carrying out more and more functions. The video play function is one of the most commonly used by a user operating a mobile terminal.

With the development of the Internet, video resources are getting richer and richer. During choosing and browsing lengthy videos, a user usually previews a video at first, and then, decides whether to play it or not. A relatively common video preview approach in a mobile terminal is where, after entering a video play interface, a user can cause an application program to display video preview pictures at different time points by clicking a play progress bar, thereby previewing the video.

### SUMMARY OF THE DISCLOSURE

When previewing a video, a corresponding video preview picture can only be displayed if a video play interface is initiated at first. In this way, in some cases, when browsing a large amount of videos, a user needs to enter a video play interface by clicking in a video list, and then perform a corresponding operation to trigger displaying a video preview picture to be previewed. If the video's content does not correspond with the user's requirement, it is necessary to close the video play interface and to continue to choose from the video list. When the number of videos is large, it is necessary to open and close the video play interface frequently, which will reduce the processing efficiency of the video preview procedure.

Thus, embodiments of the present disclosure provide a method, apparatus and a computer readable storage medium for displaying a video preview picture, to improve the processing efficiency of the video preview procedure. The technical solutions are as follows.

In one aspect, there is provided a method for displaying a video preview picture, comprising of receiving an operation signal for an item of a target video in a video list displayed on a screen; acquiring video preview picture or pictures corresponding to the target video according to pre-stored correspondence between videos and video preview pictures; and displaying the video preview picture or pictures corresponding to the target video.

In another aspect, there is provided an apparatus for displaying a video preview picture, comprising a reception module configured to receive an operation signal for an item of a target video in a video list displayed on a screen; an acquisition module configured to acquire video preview picture or pictures corresponding to the target video according to pre-stored correspondence between videos and video preview pictures; and a display module configured to display the video preview picture or pictures corresponding to the target video.

In a further aspect, there is provided a computer readable storage medium having stored thereon a computer program containing a program code, which, when executed on a computing device, performs respective steps of the method for displaying a video preview picture as described above.

The technical solutions provided by the embodiments of the present disclosure bring about the benefits as follows.

In the embodiments of the present disclosure, after an operation signal for an item of a target video in a video list displayed on a screen is received, video preview picture or pictures corresponding to the target video are acquired according to pre-stored correspondence between videos and video preview pictures and displayed. In this way, previewing a video may be carried out by operating on the video list without entering a video play interface, thereby improving the processing efficiency of the video preview procedure.

### BRIEF DESCRIPTION OF THE DRAWINGS

In order to explain technical solutions in embodiments of the present disclosure more clearly, a simple introduction of the necessary attached drawings will be given below. Apparently, the attached drawings in the description below are only some embodiments of the present disclosure. For those ordinary skilled in the art, other attached drawings may be obtained according to these attached drawings without inventive efforts.

FIG. 1 is a flowchart of a method for displaying a video preview picture provided in an embodiment of the present disclosure;

FIG. 2 is a structural schematic diagram of an apparatus for displaying a video preview picture provided in an embodiment of the present disclosure;

FIG. 3 is a structural schematic diagram of a terminal provided in an embodiment of the present disclosure; and

FIG. 4 is a schematic diagram of an interface display of the terminal provided in an embodiment of the present disclosure.

### DETAILED DESCRIPTION

In order to make the object, technical solutions and advantages of the present disclosure more clear, a further detailed description of the implementation of the present disclosure will be made in conjunction with attached drawings below.

### First Embodiment

The embodiment of the present disclosure provides a method for displaying a video preview picture, as shown in FIG. 1. The process flow of the method may include following steps 101-103.

At step 101, an operation signal for an item of a target video in a video list displayed on a screen is received.

At step 102, video preview picture or pictures corresponding to the target video are acquired according to pre-stored correspondence between videos and video preview pictures.

At step 103, the video preview picture or pictures corresponding to the target video are displayed.

In the embodiment of the present disclosure, after an operation signal for an item of a target video in a video list displayed on a screen is received, video preview picture or pictures corresponding to the target video are acquired according to pre-stored correspondence between videos and video preview pictures and displayed. In this way, previewing a video can be carried out by operating on the video list without entering a video play interface; thereby improving the processing efficiency of the video preview procedure can be improved.

### Second Embodiment

The embodiment of the present disclosure provides a method for displaying a video preview picture. This may be via a terminal with video play function or, in an embodiment, via mobile terminals such as mobile phones, tablet computers and the like. Here, the terminal may be a terminal with or without a touch screen function. The embodiment of the present disclosure uses a mobile terminal as an example in the specific description of the solution.

As shown in FIG. 1, the process flow of the method may include steps as follows.

At step 101, an operation signal for an item of a target video in a video list displayed on a screen is received.

The terminal may be installed with an application program for playing videos. An interface for displaying a video list may be set in the application program. In the interface, the video list is displayed, which contains items of respective videos. Of course, the video list herein is not necessarily displayed in the application program for playing videos but, for example, may be displayed in a file browser or directly on the desktop. Such videos may be stored in the terminal locally, or may be stored in a server at a network side. The target video may be any video in the video list. The operation signal is a signal for triggering the display of a video preview picture, and it may be, for example, a touch signal on the screen of the terminal, an operation signal input by a mouse to the terminal, or the like. The position of the touch signal can correspond to the display position of the item of the target video. The operation signal may be any signal other than the signal for opening the video play interface, which may usually be a touch signal whose duration is less than a preset duration threshold.

In an embodiment, the above operation signal is a touch signal whose duration is greater than the preset duration threshold, or a slide touch signal.

When a user needs to preview a certain target video, he/she may choose on the item of the target video in the video list, thereby triggering a corresponding operation signal. In an embodiment, the user may trigger the operation signal by long clicking or sliding on the item of the target video.

At step 102, video preview picture or pictures corresponding to the target video are acquired according to pre-stored correspondence between videos and video preview pictures.

The correspondence between videos and video preview pictures may be stored in the terminal locally, or may be stored in a server at a network side. For the case of storing in the terminal locally, the video preview picture or pictures corresponding to the target video can be directly acquired locally. For the case of storing in the server, the video preview picture or pictures of the target video can be downloaded from the server.

The server or the terminal may generate video preview pictures in advance for respective videos stored therein and, specifically, may extract one video frame from respective video frames of the videos at certain time intervals (e.g. one second) to generate an extracted picture as the video preview picture; or may extract one video frame from respective video frames of the videos at every certain number (e.g. one hundred) of video frames to generate an extracted picture as the video preview picture; or may extract one video frame from respective video frames of the videos every certain progress proportion (e.g. 1%) to generate an extracted picture as the video preview picture.

After the video preview picture or pictures are generated for videos, they may be stored and the correspondence between videos and video preview pictures may be recorded. Specifically, a correspondence table may be established, in which identifiers of videos and identifiers of video preview pictures (for example, names or storage positions of video preview pictures or the like) are stored in a manner corresponding to each other, whereby one video may correspond to one or more video preview pictures. When acquiring the video preview picture or pictures corresponding to the target video, the above correspondence table may be searched for the identifier of the corresponding video preview picture according to the identifier of the target video, so that the corresponding video preview picture is acquired.

In an embodiment, the server can generate video preview pictures for respective videos and save them. The video preview pictures corresponding to the videos may be extracted pictures of the videos at multiple progress time points. Accordingly, the video preview pictures of the target video are extracted pictures of the target video at multiple progress time points. In the procedure of loading the video list, the terminal may, for respective videos in the video list, download a preset number (e.g. five) of video preview pictures at the earliest progress time point(s) among the video preview pictures corresponding to the videos from the server and store them locally.

Based on the above process, the process of step 102 may be that a preset number of video preview picture(s) stored locally and at the earliest progress time point(s) corresponding to the target video are acquired according to pre-stored correspondence between videos and video preview pictures, and the video preview picture(s) other than the preset number of video preview picture(s) at the earliest progress time point(s) corresponding to the target video are acquired from a server. In this way, when the video preview pictures are displayed, while the video preview pictures at earlier progress time points stored locally are displayed, the remaining video preview pictures of the target video can be downloaded and subsequently displayed.

For the case that the above operation signal is a slide touch signal, the video preview picture is acquired and displayed once the sliding reaches a certain distance. Accordingly, the process of step 102 can be that the video preview picture or pictures corresponding to the target video are acquired according to pre-stored correspondence between videos and video preview pictures if the sliding distance in a preset direction of the slide touch signal is a positive integer multiple of a preset unit distance (e.g. one millimeter).

The preset direction can be any direction and, in an embodiment, is toward the right laterally along the screen. Such sliding corresponds with general sliding procedures and is more convenient to carry out. Of course, the preset direction may also be toward the left laterally along the screen, or downward (upward) longitudinally along the screen.

Accordingly, if the sliding distance in the preset direction of the slide touch signal is not a positive integer multiple of the preset unit distance, the process of acquiring and displaying the video preview picture may not be performed.

In an embodiment, the pre-stored video preview pictures of a video may be extracted pictures at multiple progress time points of the video. The specific picture extracting process has been explained in detail above; for example, one video frame can be extracted at certain time intervals (e.g. one second) to generate extracted pictures, i.e., generate extracted pictures respectively at the progress time points of one second, two seconds, three seconds and so on. Accordingly, the video preview pictures corresponding to the target video are extracted pictures of the target video at multiple progress time points.

The process of acquiring video preview pictures corresponding to the target video according to the pre-stored correspondence between videos and video preview pictures based on the sliding distance in the preset direction of the above slide touch signal may be specifically as follows.

Firstly, according to the sliding distance in the preset direction of the above slide touch signal, a corresponding preview time point is determined. The preview time point may be the progress time point of a video preview picture needing to be acquired, i.e. the progress time point of the video preview picture in the target video.

There are many ways of determining the corresponding preview time point by the sliding distance; for example, the product of the ratio of the sliding distance to the preset unit distance (e.g. one millimeter) and a preset unit time (e.g. ten seconds) may be considered as the preview time point.

In an embodiment, the ratio of the sliding distance in the preset direction of the slide touch signal to a preset maximum distance can be determined at first, and then the progress time point is obtained as the preview time point by multiplying the ratio with the total duration of the target video. The maximum distance may be set according to the width of the terminal's screen (e.g., not beyond the width of the screen), for example, five centimeters. In this way, in the procedure of the sliding distance in the preset direction of the slide touch signal changing from 0 toward the maximum distance, the displayed video preview pictures will create the effect of playing the target video at high speed.

Then, the video preview picture at a progress time point closest to the preview time point is acquired from the video preview picture(s) corresponding to the target video, according to the pre-stored correspondence between videos and video preview pictures.

The video preview pictures corresponding to the target video are extracted pictures of the target video at multiple progress time points. Accordingly, the progress time point of the video preview picture is the progress time point of the corresponding extracted picture of the video preview picture in the target video. The progress time point of the video preview picture can be recorded in files of the video preview picture, such as, in the file name.

At step 103, the video preview picture(s) corresponding to the target video are displayed.

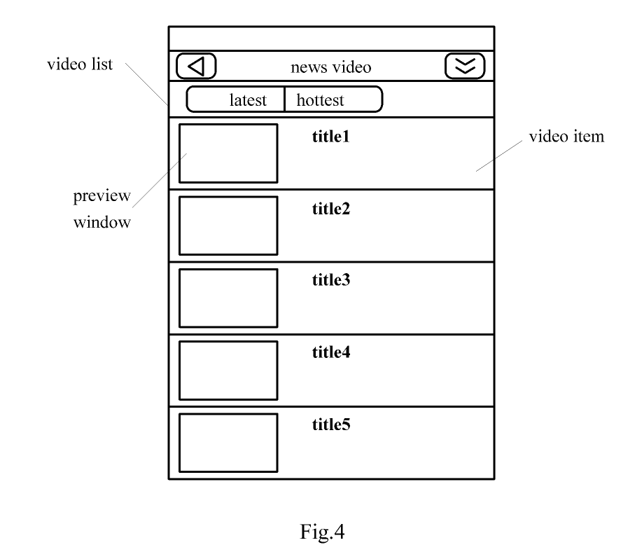

Specifically, the video preview picture corresponding to the target video can be displayed at a display position corresponding to the item of the target video. In an embodiment, as shown in FIG. 4, a preview window can be set in the display region of the item of each video for displaying the video preview picture.

When displaying the video preview picture(s) corresponding to the target video, there may be a variety of display modes. In the following, some preferable display modes are given.

In a first mode, sequence information of the video preview pictures corresponding to the target video is acquired and, according to the sequence information, the video preview pictures corresponding to the target video are displayed sequentially in a preset time interval (e.g. 0.5 second).

The sequence information may be defined sequential numbers, or may be the progress time points as described above and so on. The sequence information can be recorded in the files of the video preview picture, such as in the file name.

The video preview pictures are displayed sequentially by such display mode, so that the effect of playing the target video at high speed can be created. In this way, the efficiency of previewing can be improved.

In a second mode, sequence information of the video preview pictures corresponding to the target video is acquired and, according to the sequence information, the video preview pictures corresponding to the target video are displayed in a spatial arrangement.

Specifically, multiple video preview pictures can be arranged according to the sequence information and be displayed at respective display positions at the same time. If there are too many video preview pictures or the display region for displaying the video preview pictures is small, it is possible for only a part of the video preview pictures to be displayed in a spatial arrangement; for example, one video preview picture is extracted every four video preview pictures and is displayed according to the sequence information. By employing such display mode, the efficiency of previewing can be improved.

In the embodiment of the present disclosure, after an operation signal for an item of a target video in a video list displayed on a screen is received, video preview picture or pictures corresponding to the target video are acquired according to pre-stored correspondence between videos and video preview pictures and displayed. In this way, previewing a video can be carried out by operating on the video list without entering a video play interface; thereby the processing efficiency of the video preview procedure can be improved.

### Third Embodiment

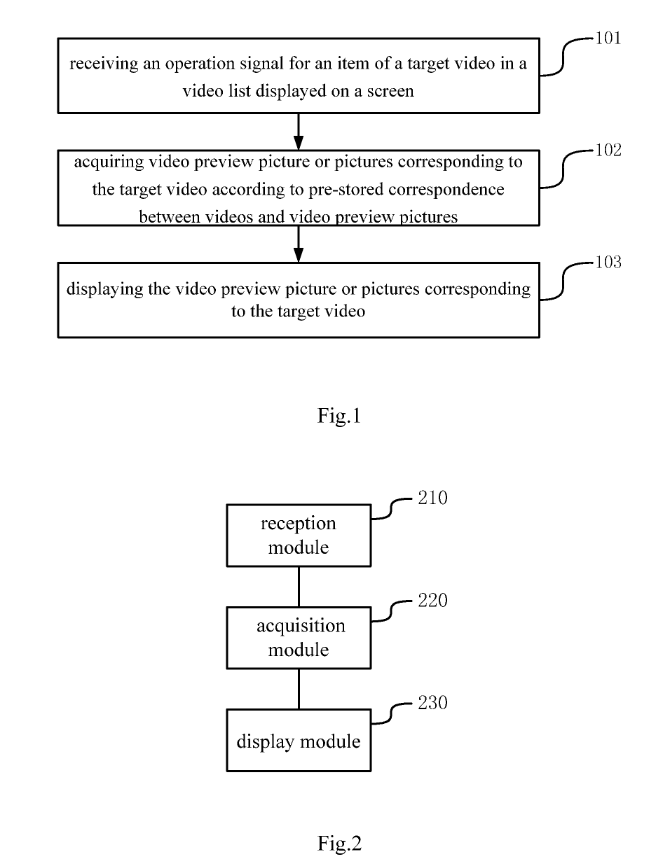

Based on the same technical concept, the embodiment of the present disclosure further provides an apparatus for displaying a video preview picture, as shown in FIG. 2. The apparatus includes a reception module 210 configured to receive an operation signal for an item of a target video in a video list displayed on a screen; an acquisition module 220 configured to acquire video preview picture or pictures corresponding to the target video according to pre-stored correspondence between videos and video preview pictures; and a display module 230 configured to display the video preview picture or pictures corresponding to the target video.

In an embodiment, the operation signal is a touch signal whose duration is greater than a preset duration threshold or a slide touch signal.

In an embodiment, the operation signal is a slide touch signal, and the acquisition module 220 is configured to acquire the video preview picture or pictures corresponding to the target video according to the pre-stored correspondence between videos and video preview pictures if the sliding distance in a preset direction of the slide touch signal is a positive integer multiple of a preset unit distance.

In an embodiment, the operation signal is a slide touch signal, and the video preview picture(s) corresponding to the target video are extracted pictures of the target video at multiple progress time points. The acquisition module 220 is configured to determine a corresponding preview time point according to the sliding distance in the preset direction of the slide touch signal, and to acquire the video preview picture at a progress time point closest to the preview time point in the video preview pictures corresponding to the target video according to the pre-stored correspondence between videos and video preview pictures.

In an embodiment, the acquisition module 220 is configured to determine the ratio of the sliding distance in the preset direction of the slide touch signal to a preset maximum distance, and to take the progress time point obtained by multiplying the ratio with the total duration of the target video as the preview time point.

In an embodiment, the preset direction is toward the right laterally along the screen.

In an embodiment, the video preview picture(s) corresponding to the target video are extracted pictures of the target video at multiple progress time points, and the acquisition module 220 is configured to acquire a preset number of video preview picture(s) stored locally and at the earliest progress time point(s) corresponding to the target video according to the pre-stored correspondence between videos and video preview pictures, and to acquire the video preview picture(s) other than the preset number of video preview pictures at the earliest progress time point(s) corresponding to the target video from a server.

In an embodiment, the display module 230 is configured to display the video preview picture(s) corresponding to the target video at a display position corresponding to the item of the target video.

In an embodiment, the display module 230 is configured to acquire sequence information of the video preview pictures corresponding to the target video, and to display the video preview pictures corresponding to the target video sequentially at a preset time interval according to the sequence information.

In an embodiment, the display module 230 is configured to acquire sequence information of the video preview pictures corresponding to the target video, and to display the video preview pictures corresponding to the target video in a spatial arrangement according to the sequence information.

In the embodiment of the present disclosure, after an operation signal for an item of a target video in a video list displayed on a screen is received, video preview picture or pictures corresponding to the target video are acquired according to pre-stored correspondence between videos and video preview pictures and displayed. In this way, previewing a video can be carried out by operating on the video list without entering a video play interface, thereby improving the processing efficiency of the video preview procedure.

### Fourth Embodiment

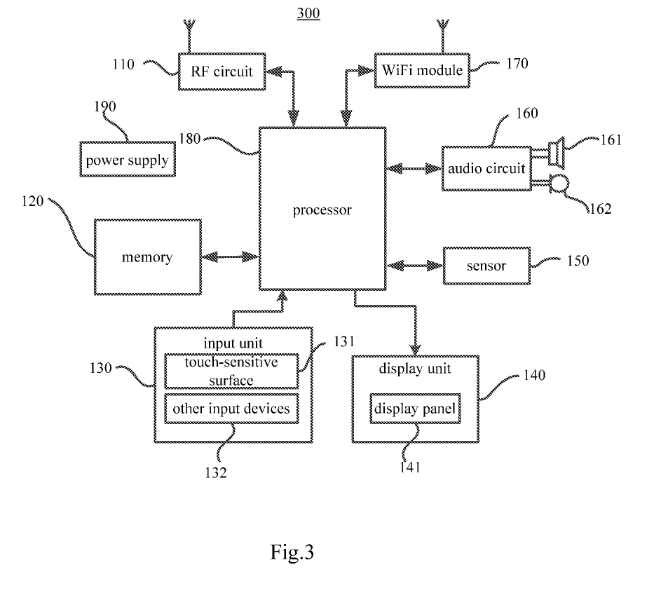

Please see FIG. 3, which shows a structural schematic diagram of a terminal with a touch-sensitive surface applicable to embodiments of the present disclosure. The terminal may be used to implement the method for displaying a video preview picture provided in the above embodiments. The detail thereof is as follows.

A terminal 300 may include means such as an RF (Radio Frequency) circuit 110, a memory 120 containing one or more computer readable storage media, an input unit 130, a display unit 140, a sensor 150, a audio circuit 160, a WiFi (wireless fidelity) module 170, a processor 180 containing one or more processing cores, a power supply 190 and so on. It is understood by those skilled in the art that the structure of the terminal shown in FIG. 3 is not limiting of the terminal, and it may include more or less means than those illustrated, or combine some means, or include different means arrangements.

The RF circuit 110 may be used to receive and transmit signals in the process of information reception and transmission or communication, and particularly, after receiving downlink information from a base station, to deliver the same to one or more processors 180 for processing and, in addition, to transmit data related to uplink to the base station. Generally, the RF circuit 110 includes, but is not limited to, an antenna, at least one amplifier, a tuner, one or more oscillators, a SIM (Subscriber Identity Module) card, a transceiver, a coupler, an LNA (Low Noise Amplifier), a duplexer and so on. In addition, the RF circuit 110 may further communicate with a network and other devices via wireless communication. The wireless communication may use any communication standard or protocol, including, but not limited to, GSM (Global System of Mobile communication), GPRS (General Packet Radio Service), CDMA (Code Division Multiple Access), WCDMA (Wideband Code Division Multiple Access), LTE (Long Term Evolution), E-mail, SMS (Short Messaging Service) and so on.

The memory 120 may be used to store software programs and modules, and the processor 180 performs various functional applications and data processing by running the software programs and modules stored in the memory 120. The memory 120 may include a program storage region and a data storage region. The program storage region may store an operating system, an application program required by at least one function (for example, sound play function, image play function, etc) and so on, while the data storage region may store data created according to the use of the terminal 300 (for example, audio data, phone book, etc) and so on. In addition, the memory 120 may include a high-speed random access memory, or a non-volatile memory (for example, at least one disk storage device, flash memory device, or other volatile solid-state storage devices). Accordingly, the memory 120 may further include a memory controller for providing the access to the memory 120 for the processor 180 and the input unit 130.

The input unit 130 may be used for receiving input digital or character information and producing keyboard, mouse, operating lever, optical or trackball signal input related to user setting and function controlling. Specifically, the input unit 130 may include a touch-sensitive surface 131 and other input device 132. The touch-sensitive surface 131, which is also referred to as touch screen or touchpad, may collect touches of a user thereon or in the vicinity thereof (for example, operations on the touch-sensitive surface 131 or in the vicinity of the touch-sensitive surface 131 by a user using any suitable object or attachment such as a finger, a stylus, etc.) and drive corresponding connection apparatuses according to preset programs. Optionally, the touch-sensitive surface 131 may include two parts, i.e. a touch detection apparatus and a touch controller. The touch detection apparatus detects the touch orientation of the user, detects a signal from the touch, and transmits that signal to the touch controller, while the touch controller receives touch information from the touch detection apparatus, converts it into a touch point coordinate and then transmits the coordinate to the processor 180, and is capable of receiving a command transmitted from the processor 180 and executing the command. Furthermore, the touch-sensitive surface 131 may be implemented in a variety of forms such as resistor, capacitor, infrared, surface acoustic wave and so on. In addition to the touch-sensitive surface 131, the input unit 130 may include other input devices 132. Specifically, the other input devices 132 may include, but are not limited to, one or more of physical keyboard, function key (for example, volume control button, switch button, etc), trackball, mouse, operating level and so on.

The display unit 140 may be used for displaying information input by a user or information provided to the user as well as various graphical user interfaces of the terminal 300, which may be composed of graph, text, icon, video, and any combination thereof. The display unit 140 may include a display panel 141 and, optionally, the display panel 141 may be configured in forms of LCD (Liquid Crystal Display), OLED (Organic Light-Emitting Diode) and so on. Further, the touch-sensitive surface 131 may cover the display panel 141. The touch-sensitive surface 131, after detecting a touch thereon or in the vicinity thereof, transmits it to the processor 180 to determine the type of touch event, and the processor 180 then provides a corresponding visual output on the display panel 141 according to the type of touch event. Although the touch-sensitive surface 131 and the display panel 141 implement input and output functions as two separate means in FIG. 3, in some embodiments, the touch-sensitive surface 131 and the display panel 141 may be integrated to implement input and output functions.

The terminal 300 may further include at least one kind of sensor 150 (for example, an optical sensor, a motion sensor or other sensors). Specifically, the optical sensor may include an ambient light sensor and a proximity sensor. The ambient light sensor may adjust the brightness of the display panel 141 according to brightness and darkness of the ambient light, while the proximity sensor turns off the display panel 141 and/or backlight when the terminal 300 moves to the ear. A gravity acceleration sensor as one kind of motion sensor may detect the magnitude of accelerations in respective directions (generally three axes) and may detect, when keeping stationary, the magnitude and direction of the gravity which may be applied to an application of identifying the attitude of a mobile phone (for example, switching between a horizontal screen and a vertical screen, related games, magnetometer attitude calibration), a function related to vibration recognition (for example, pedometer, tapping) and so on. Other sensors such as a gyroscope, a barometer, a hygrometer, a thermometer, an infrared sensor and so on that may be further configured by the terminal will not be described in detail for avoiding redundancy.

The audio circuit 160, a speaker 161 and a microphone 162 may provide audio interfaces between a user and the terminal 300. The audio circuit 160 may transmit the electrical signal converted from the received audio data to the speaker 161, and the speaker 161 converts the electrical signal into an audio signal and outputs it. On the other hand, the microphone 162 converts the collected audio signal into an electrical signal, the audio circuit 160 receives the electrical signal, converts it into audio data, and then outputs the audio data to the processor 180 to be processed and transmitted to, for example, another terminal via the RF circuit 110, or outputs the audio data to the memory 120 to be further processed. The audio circuit 160 may further include an earplug jack for providing communication between a peripheral headset and the terminal 300.

WiFi belongs to the short-distance wireless transmission technology, and the terminal 300 may help a user receive and send E-mails, browse web pages and access streaming media through the WiFi module 170, which provides a user with the wireless broadband Internet access. Although FIG. 3 shows the WiFi module 170, it is understood that the WiFi module 170 does not belong to the necessary configuration of the terminal 300 and may be omitted completely as necessary without changing the essential scope of the present disclosure.

The processor 180 is the control center of the terminal 300, and uses various interfaces and links to connect respective parts of the whole mobile phone, and performs respective functions of the terminal 300 and processes data by running or executing software programs and/or modules stored in the memory 120 and invoking data stored in the memory 120 so as to conduct overall monitoring of the mobile phone. Optionally, the processor 180 may include one or more processing cores. In an embodiment, the processor 180 may integrate an application processor and a modem processor therein, with the application processor processing the operating system, user interfaces, application programs and so on while the modem processor processes wireless communication. It is understood that the modem processor may also not be integrated into the processor 180.

The terminal 300 further includes the power supply 190 (for example, a battery) supplying power for respective means. In an embodiment, the power supply may be connected logically to the processor 180 via a power management system, so that functions such as charging management, discharging management, power consumption management and so on are implemented through the power management system. The power supply 190 may further include any one or more components such as direct-current (DC) or alternating-current (AC) power supplies, recharging power systems, power failure detection circuits, power converters or inverters, power status indicators and so on.

Although not shown, the terminal 300 may further include a camera, a Bluetooth module and so on, and there is no detailed description thereof here to avoid redundancy. Specifically, in the present embodiment, the display unit of the terminal is a touch screen display, and the terminal further includes the memory and one or more programs, which are stored in the memory, and it is configured that one or more processors execute instructions for performing the following operations contained in the above one or more programs receiving an operation signal for an item of a target video in a video list displayed on a screen; acquiring video preview picture or pictures corresponding to the target video according to pre-stored correspondence between videos and video preview pictures; and displaying the video preview picture or pictures corresponding to the target video.

Assuming that the described above is the first possible implementation, in the second possible implementation provided on the basis of the first possible implementation, the operation signal is a touch signal whose duration is greater than a preset duration threshold or a slide touch signal.

In the third possible implementation provided on the basis of the first possible implementation, the operation signal is a slide touch signal, and acquiring the video preview picture or pictures corresponding to the target video according to pre-stored correspondence between videos and video preview pictures includes acquiring the video preview picture or pictures corresponding to the target video according to the pre-stored correspondence between videos and video preview pictures if the sliding distance in a preset direction of the slide touch signal is a positive integer multiple of a preset unit distance.

In the fourth possible implementation provided on the basis of the first possible implementation, the operation signal is a slide touch signal, the video preview picture(s) corresponding to the target video are extracted pictures of the target video at multiple progress time points, and acquiring the video preview picture(s) corresponding to the target video according to pre-stored correspondence between videos and video preview pictures includes determining a corresponding preview time point according to the sliding distance in the preset direction of the slide touch signal; and acquiring the video preview picture at a progress time point closest to the preview time point in the video preview picture(s) corresponding to the target video according to the pre-stored correspondence between videos and video preview pictures.

In the fifth possible implementation provided on the basis of the fourth possible implementation, determining a corresponding preview time point according to the sliding distance in the preset direction of the slide touch signal includes determining the ratio of the sliding distance in the preset direction of the slide touch signal to a preset maximum distance; and taking the progress time point obtained by multiplying the ratio with the total duration of the target video as the preview time point.

In the sixth possible implementation provided based on the third, fourth or fifth possible implementation, the preset direction is toward the right laterally along the screen.

In the seventh possible implementation provided on the basis of the first possible implementation, the video preview picture(s) corresponding to the target video are extracted pictures of the target video at multiple progress time points, and acquiring video preview picture or pictures corresponding to the target video according to pre-stored correspondence between videos and video preview pictures includes acquiring a preset number of video preview picture(s) stored locally and at the earliest progress time point(s) corresponding to the target video according to the pre-stored correspondence between videos and video preview pictures, and acquiring the video preview picture(s) other than the preset number of video preview picture(s) at the earliest progress time point corresponding to the target video from a server.

In the eighth possible implementation provided based on the first possible implementation, displaying the video preview picture(s) corresponding to the target video includes displaying the video preview picture(s) corresponding to the target video at a display position corresponding to the item of the target video.

In the ninth possible implementation provided based on the first possible implementation, displaying the video preview picture(s) corresponding to the target video includes acquiring sequence information of the video preview pictures corresponding to the target video; and displaying the video preview pictures corresponding to the target video sequentially at a preset time interval according to the sequence information.

In the tenth possible implementation provided based on the first possible implementation, displaying the video preview picture(s) corresponding to the target video includes acquiring sequence information of the video preview pictures corresponding to the target video; and displaying the video preview pictures corresponding to the target video in a spatial arrangement according to the sequence information.

In the embodiment of the present disclosure, after an operation signal for an item of a target video in a video list displayed on a screen is received, video preview picture or pictures corresponding to the target video are acquired according to pre-stored correspondence between videos and video preview pictures and displayed. In this way, previewing a video may be carried out by operating on the video list without entering a video play interface, thereby improving the processing efficiency of the video preview procedure.

It is noted that, when the apparatus for displaying a video preview picture provided in the above embodiment displays the video preview picture(s), the description thereof is made by taking the above division of respective functional modules only as an example. In a practical application, the above functions may be allocated to different functional modules to be completed as necessary, i.e., the internal structure of the apparatus is divided into different functional modules to complete all or part of functions as described above. In addition, the apparatus for displaying a video preview picture provided in the above embodiment belongs to the same concept as the embodiments of the method for displaying a video preview picture, specific implementation procedure thereof refers to the method embodiments, and the detailed description thereof will not be given here to avoid redundancy.

The above embodiment numbers are only for the purpose of description, and are not representative of superiority and inferiority of embodiments.

It can be understood by those ordinary skilled in the art that all or part of the steps for implementing the embodiments as described above may be completed by hardware, or may be completed by related hardware instructed by a program which may be stored in a computer readable storage medium which may be a Read Only Memory, a magnetic disk, an optical compact disc or the like. For example, the present disclosure may be implemented as a computer readable storage medium having stored thereon a computer program containing a program code, which, when executed on a computing device, performs respective steps of the method for displaying a video preview picture as described above.

The described above are only preferable embodiments of the present disclosure and are not intended to limit the present disclosure. Any modification, equivalent replacement, improvement, etc made within the spirit and principle of the present disclosure should all be contained within the protection scope of the present disclosure.

What is claimed is:

1. A method for displaying a video preview picture, comprising:
receiving an operation signal for an item of a target video in a video list displayed on a screen;
acquiring one or more video preview pictures corresponding to the target video according to pre-stored correspondence between videos and the one or more video preview pictures; and
displaying the one or more video preview pictures corresponding to the target video.

2. The method according to claim 1, wherein the operation signal is a touch signal whose duration is greater than a preset duration threshold or a slide touch signal.

3. The method according to claim 1, wherein the operation signal is a slide touch signal,
the acquiring one or more video preview pictures corresponding to the target video according to pre-stored correspondence between videos and the one or more video preview pictures comprises:
acquiring the one or more video preview pictures corresponding to the target video according to the pre-stored correspondence between videos and the one or more video preview pictures if a sliding distance in a preset direction of the slide touch signal is a positive integer multiple of a preset unit distance.

4. The method according to claim 1, wherein the operation signal is a slide touch signal, the one or more video preview pictures corresponding to the target video are extracted pictures of the target video at multiple progress time points,
the acquiring one or more video preview pictures corresponding to the target video according to pre-stored correspondence between videos and the one or more video preview pictures comprises:
determining a corresponding preview time point according to the sliding distance in the preset direction of the slide touch signal; and
acquiring the one or more video preview pictures at a progress time point closest to the preview time point in one or more the video preview pictures corresponding to the target video according to the pre-stored correspondence between videos and video preview pictures.

5. The method according to claim 4, wherein the determining of a corresponding preview time point according to the sliding distance in the preset direction of the slide touch signal comprises:
determining the ratio of the sliding distance in the preset direction of the slide touch signal to a preset maximum distance; and
taking the progress time point obtained by multiplying the ratio with the total duration of the target video as the preview time point.

6. The method according to claim 3, wherein the preset direction is toward the right laterally along the screen.

7. The method according to claim 1, wherein the one or more video preview picture or pictures corresponding to the target video are extracted pictures of the target video at multiple progress time points,
the acquiring one or more video preview pictures corresponding to the target video according to pre-stored correspondence between videos and the one or more video preview pictures comprises:
acquiring a preset number of one or more video preview pictures stored locally and at the earliest progress time point or points corresponding to the target video according to the pre-stored correspondence between videos and the one or more video preview pictures, and acquiring the one or more video preview pictures other than the preset number of the one or more video preview pictures at the earliest progress time point or points corresponding to the target video from a server.

8. The method according to claim 1, wherein the displaying of the one or more video preview pictures corresponding to the target video comprises:
displaying the one or more video preview pictures corresponding to the target video at a display position corresponding to the item of the target video.

9. The method according to claim 1, wherein the displaying of the one or more video preview pictures corresponding to the target video comprises:
acquiring sequence information of the one or more video preview pictures corresponding to the target video; and
displaying the one or more video preview pictures corresponding to the target video sequentially in a preset time interval according to the sequence information.

10. The method according to claim 1, wherein the displaying of the one or more video preview pictures corresponding to the target video comprises:
acquiring sequence information of the one or more video preview pictures corresponding to the target video; and
displaying the one or more video preview pictures corresponding to the target video in a spatial arrangement manner according to the sequence information.

11. An apparatus for displaying a video preview picture, comprising:
a reception module configured to receive an operation signal for an item of a target video in a video list displayed on a screen;
an acquisition module configured to acquire video preview picture or pictures corresponding to the target video according to pre-stored correspondence between videos and video preview pictures; and
a display module configured to display the video preview picture or pictures corresponding to the target video.

12. The apparatus according to claim 11, wherein the operation signal is a touch signal whose duration is greater than a preset duration threshold or a slide touch signal.

13. The apparatus according to claim 11, wherein the operation signal is a slide touch signal,
the acquisition module is configured to acquire video preview picture or pictures corresponding to the target video according to the pre-stored correspondence between videos and video preview pictures if a sliding distance in a preset direction of the slide touch signal is a positive integer multiple of a preset unit distance.

14. The apparatus according to claim 11, wherein the operation signal is a slide touch signal, the video preview picture or pictures corresponding to the target video are extracted pictures of the target video at multiple progress time points,
the acquisition module is configured to:
determine a corresponding preview time point according to the sliding distance in the preset direction of the slide touch signal; and
acquire the video preview picture at a progress time point closest to the preview time point in the video preview picture or pictures corresponding to the target video according to the pre-stored correspondence between videos and video preview pictures.

15. The apparatus according to claim 14, wherein the acquisition module is configured to:
determine the ratio of the sliding distance in the preset direction of the slide touch signal to a preset maximum distance; and
take the progress time point obtained by multiplying the ratio with the total duration of the target video as the preview time point.

16. The apparatus according to claim 13, wherein the preset direction is toward the right laterally along the screen.

17. The apparatus according to claim 11, wherein the video preview picture or pictures corresponding to the target video are extracted pictures of the target video at multiple progress time points,
the acquisition module is configured to:
acquire a preset number of video preview picture or pictures stored locally and at the earliest progress time point or points corresponding to the target video according to the pre-stored correspondence between videos and video preview pictures, and acquire the video preview picture or pictures other than the preset number of video preview picture or pictures at the earliest progress time point or points corresponding to the target video from a server.

18. The apparatus according to claim 11, wherein the display module is configured to:
display the video preview picture or pictures corresponding to the target video at a display position corresponding to the item of the target video.

19. The apparatus according to claim 11, wherein the display module is configured to:
acquire sequence information of the video preview pictures corresponding to the target video; and
display the video preview pictures corresponding to the target video sequentially in a preset time interval according to the sequence information.

20. The apparatus according to claim 11, wherein the display module is configured to:
acquire sequence information of the video preview pictures corresponding to the target video; and
display the video preview pictures corresponding to the target video in a spatial arrangement manner according to the sequence information.

21. A computer readable storage medium having stored thereon a computer program containing a program code, which, when executed on a computing device, performs respective steps of the method for displaying a video preview picture according to claim 1.
